(19) United States
(12) Patent Application Publication
(10) Pub. No.: US 2023/0365181 A1
(43) Pub. Date: Nov. 16, 2023

(54) Sail Wheel

(71) Applicant: Sean Glenn Cunningham, North York (CA)

(72) Inventor: Sean Glenn Cunningham, North York (CA)

(21) Appl. No.: 18/197,043

(22) Filed: May 13, 2023

Related U.S. Application Data
(60) Provisional application No. 63/342,134, filed on May 15, 2022.

(51) Int. Cl. B62B 15/00; B62H 1/12; B62K 1/00

(52) U.S. Cl. CPC B62B 15/004; B62H 1/12; B62K 1/00; B60B 1/00

(57) ABSTRACT

A sail wheel includes a large wheel with a sail that is ridden on an outrigger attached to an axle of the large wheel. The outrigger includes a handle section and a foot stand section, allowing a user to ride and control the sail wheel. The sail wheel utilizes wind power for propulsion and is used on land for extreme sports or recreationally.

### CROSS-REFERENCE TO RELATED APPLICATION

The present application is related to and claims priority to U.S. Provisional Pat. Application No. 63/342,134 filed May 15, 2022, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of sports apparatus of existing art and more specifically relates to sport apparatus utilizing wind power for propulsion.

### Related Art

Extreme sports, or adventure sports, are activities usually involving a high degree of speed and a high degree of risk. Some examples of extreme sports include windsurfing, snowboarding, mountain biking, scuba diving, etc. The extreme sport industry is a billion dollar industry. However, some of these extreme sports may also be enjoyed casually. For example, windsurfing is a wind propelled water sport that employs the use of a sailboard and may be enjoyed as an extreme sport or may be performed as a leisurely activity. With the popularity of windsurfing and extreme sports as a whole, it is preferable to provide a new wind propelled apparatus which can be used both in extreme sports and casually.

### SUMMARY OF THE INVENTION

In view of the foregoing disadvantages inherent in the known sports apparatus art, the present disclosure provides a novel sail wheel. The general purpose of the present disclosure, which will be described subsequently in greater detail, is to provide a land sail apparatus that uses a sail to capture wind and propel the land sail apparatus, providing a rider with casual fun and/or extreme sporting use.

A land sail apparatus is disclosed herein. In some embodiments, the land sail apparatus may include a wheel, an axle, a sail and a riding assembly. The wheel may be configured for contacting a land surface. The axle may be attached to a center of the wheel and the wheel may be configured to rotate about the axle. The sail may be attached at the wheel and configured to capture wind to cause rotation of the wheel about the axle, thereby propelling the land sail apparatus. The riding assembly may be attached to the axle and include a foot stand section configured to receive at least one foot of a user, and a handle section configured to receive at least one of hand of the user. As such, the riding assembly may enable the user to ride and control the land sail apparatus.

According to other embodiments, the land sail apparatus may include a wheel, an axle, a sail, an outrigger, a foot stand section and a handlebar section. The wheel may be configured for contacting a land surface. The axle may be attached to a center of the wheel, the wheel configured to rotate about the axle. The outrigger may be attached to the axle. The foot stand section may be attached about a bottom end of the outrigger and configured to receive feet of a user. The handlebar section may be attached about a top end of the outrigger and configured to receive hands of the user. Thus, the foot stand section and the handlebar section may enable the user to ride and control the land sail apparatus.

According to another embodiment, a method of using a land sail apparatus is also disclosed herein. The method may include the steps of: providing the land sail apparatus; placing a foot on the foot stand section; placing at least one hand on the handle section; pushing off from the land surface via the other foot, thereby beginning rotation of the wheel and thus propelling the land sail apparatus, the propulsion of the land sail apparatus being continued by wind power captured at the sail; and controlling the land sail apparatus via at least one of the handle section and the foot stand section.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a sail wheel, constructed and operative according to the teachings of the present disclosure.

FIG. 1 is a rear perspective view of a land sail apparatus including a wheel, an axle, a sail, an outrigger, a handle section and a foot stand section, according to an embodiment of the disclosure.

FIG. 2 is a front perspective view of the land sail apparatus and illustrating the sail attached to the wheel, according to an embodiment of the present disclosure.

FIG. 3 is a rear view of the land sail apparatus illustrating the outrigger, the handle section and the foot stand section, according to an embodiment of the present disclosure.

FIG. 4 is a side view of the land sail apparatus illustrating the wheel and the outrigger, according to an embodiment of the present disclosure.

FIG. 5 is a rear perspective view of a land sail apparatus including a wheel, an axle, a sail, an outrigger, a handle section, a foot stand section, and an outrigger wheel, according to another embodiment of the disclosure.

FIG. 6 is a front perspective view of the land sail apparatus illustrating the sail attached to the wheel, according to another embodiment of the present disclosure.

FIG. 7 is a rear view of the land sail apparatus illustrating the outrigger, the handle section, the foot stand section and the outrigger wheel, according to another embodiment of the present disclosure.

FIG. 8 is a cross-section view taken from line 8-8 in FIG. 2 and illustrating a peripheral channel in a rim of the wheel and at least one peripheral fastener attached to the sail, according to an embodiment of the present disclosure.

FIG. 9 is a flow diagram illustrating a method of using a land sail apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a sail wheel. Generally, the sail wheel may include a large wheel with a sail that is ridden on an outrigger attached to an axle. The sail wheel may be similar to a sailboard in that it is propelled by wind power, however, the sail wheel is preferably used on land. The sail wheel may be used for recreation. In some embodiments, the sail wheel may be used in extreme sports.

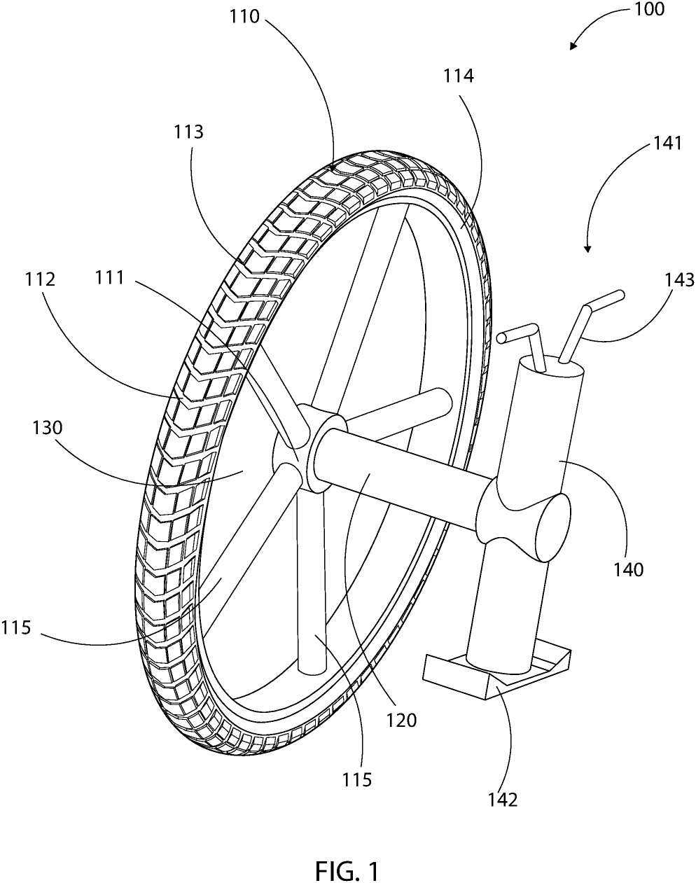

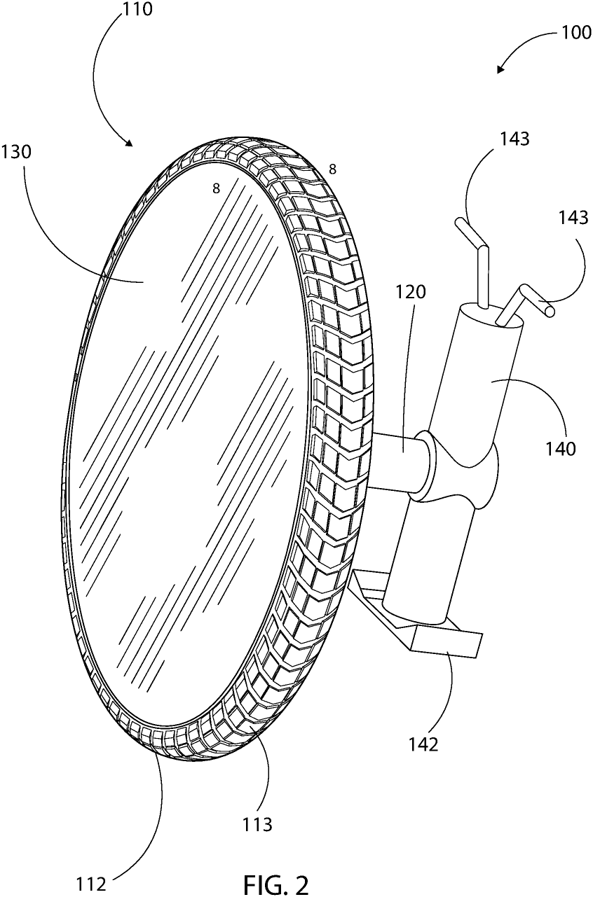

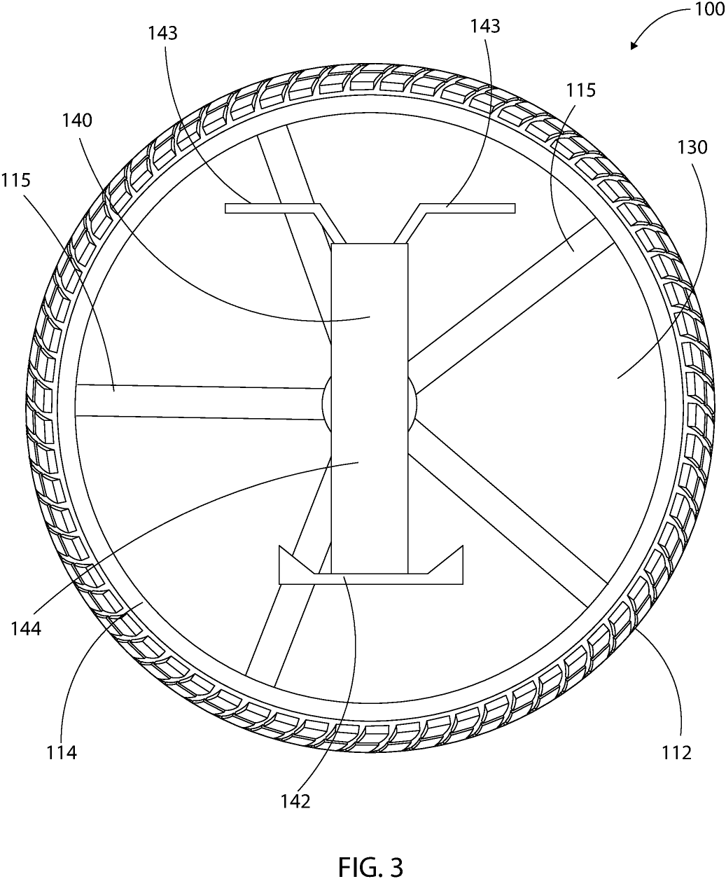

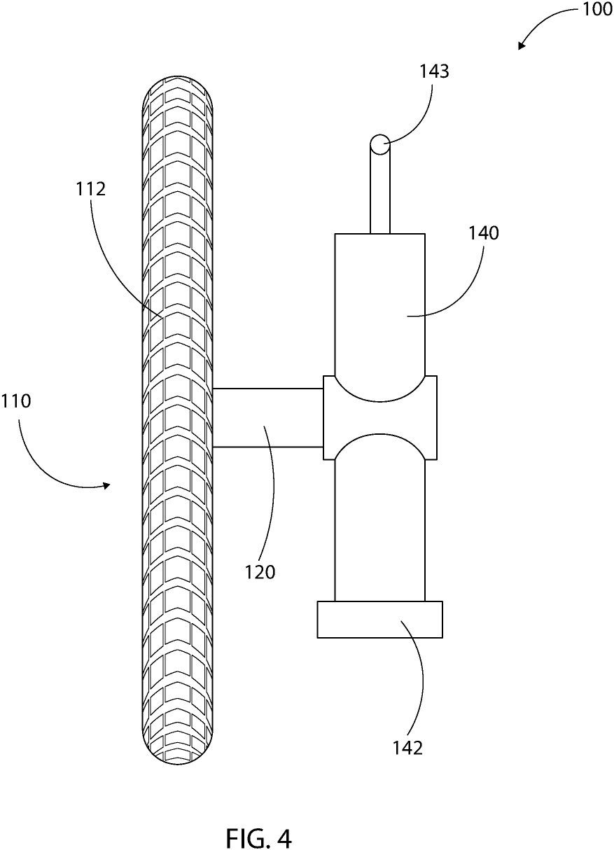

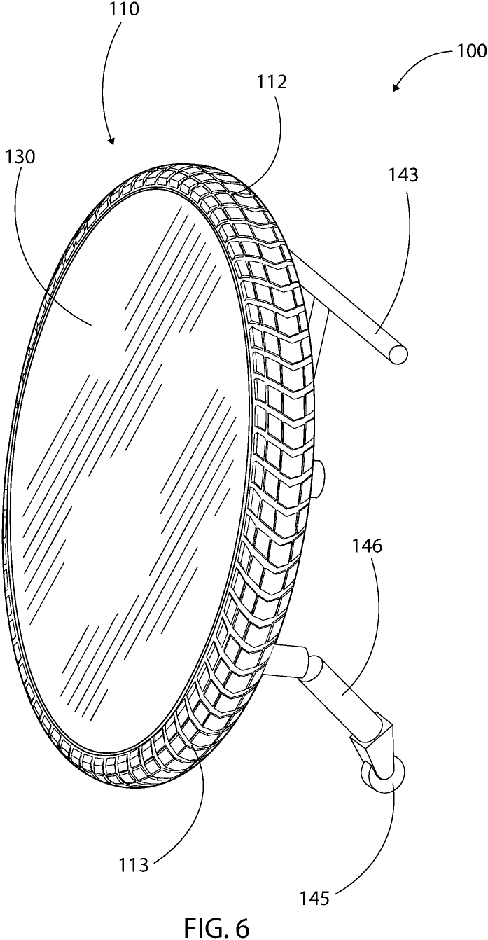

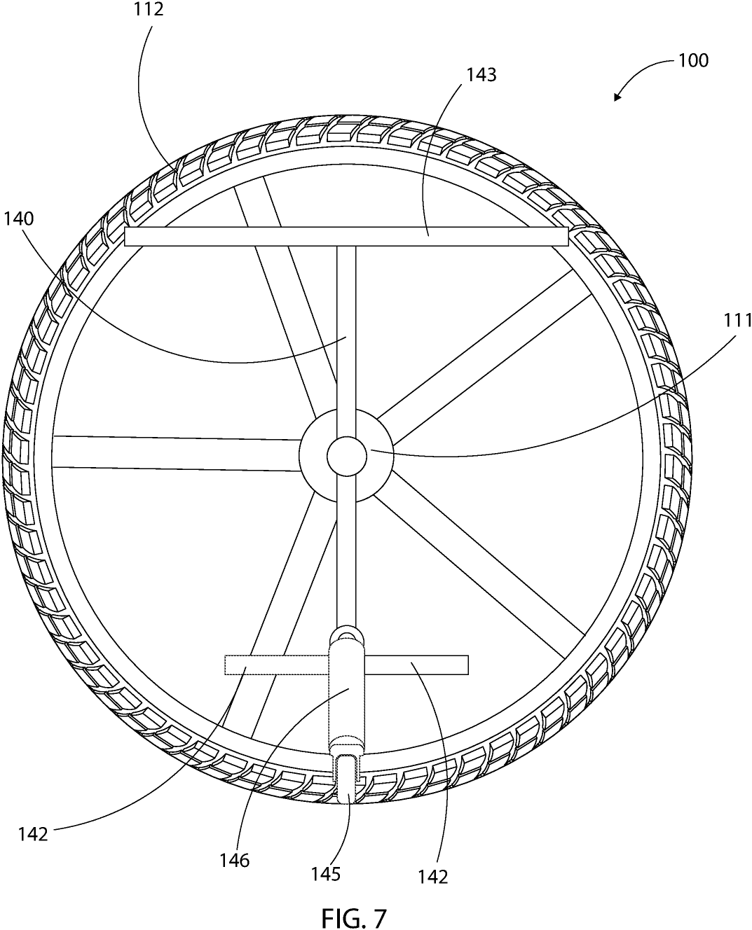

Referring now more specifically to the drawings by numerals of reference, there is shown in FIGS. 1-8, various views of a land sail apparatus 100. As shown, the land sail apparatus 100 may include a wheel 110, an axle 120, a sail 130 and an outrigger 140. As above, the land sail apparatus 100 may utilize wind power for propulsion and may preferably be used on land.

As such, the wheel 110 may be configured for contacting a land surface. As shown in FIGS. 1-7 the wheel 110 may be a single large wheel. Particularly, in some embodiments the wheel 110 may include (but is not limited to) a diameter of 8 feet. As shown, the wheel 110 may include a tire 112, a rim 114, the axle 120 attached to a center of the wheel 110 around which the wheel 110 is configured to rotate, and a plurality of equally spaced spokes 115 extending radially from the center of the wheel 110. In some embodiments, the tire 112 may include a rubber tire having treads 113 for providing grip to the wheel 110 on the land surface.

The outrigger 140 may be provided as part of a riding assembly 141 on which a user rides and controls the land sail apparatus 100. The axle 120 may extend parallel to the land surface from the center of the wheel 110. The outrigger 140 may be attached to the axle 120 perpendicular to the axle 120 and the land surface. Particularly, the outrigger 140 may include an elongated shaft 144 attached to the axle 120 at substantially a center-point of the elongated shaft 144 and oriented perpendicular to the axle 120.

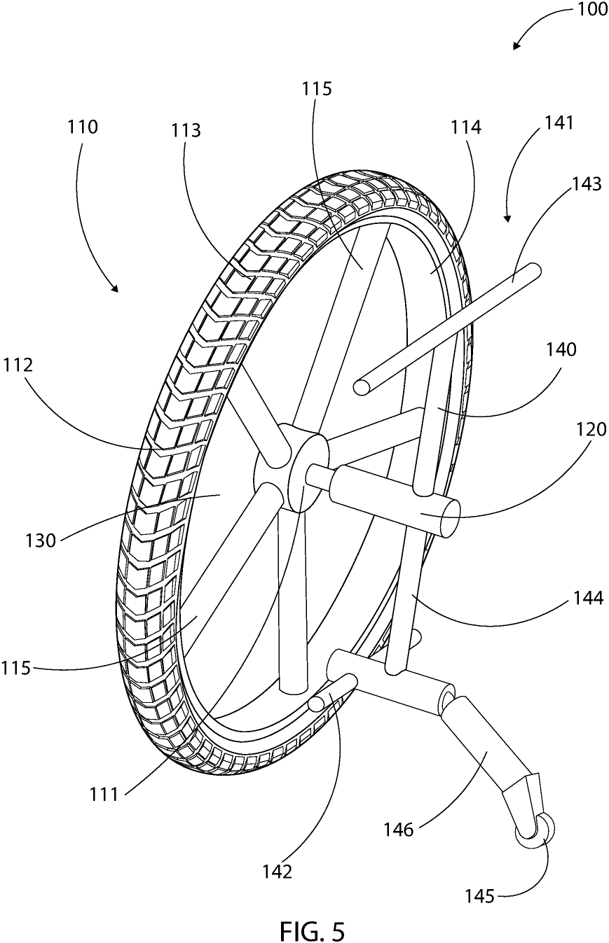

Further, the riding assembly 141 may include a foot stand section 142 configured to receive at least one foot of the user, and a handle section 143 configured to receive at least one hand of the user, thereby enabling the user to ride and control the land sail apparatus 100. As shown, the foot stand section 142 may be attached at (or near to) a bottom end of the outrigger 140, and the handle section 143 may be attached at (or near to) a top end of the outrigger 140. As shown in FIGS. 1-4, the foot stand section 142 may include a rectangular platform with upstanding left and right side walls. Further, the handle section 143 may include a pair of handle bars generally forming a V-shape. Particularly, each of the handle bars may include an angled portion and a horizontal portion, with both angled portions forming the V-shape. As shown in FIGS. 5-7, in other embodiments, the foot stand section 142 and the handle section 143 may both include elongated horizontal bars extending perpendicular to the outrigger 140.

Further, in some embodiments, as shown in FIGS. 5-7, the outrigger 140 may include at least one outrigger wheel 145 for contacting the land surface and providing stabilization and support to the wheel 110. Particularly, in some embodiments, the bottom end of the outrigger 140 may further include a stabilizer leg 146 to which the at least one outrigger wheel 145 is attached. Particularly, as shown in FIGS. 5-7, the at least one outrigger wheel 145 may be attached to a bottom of the stabilizer leg 146. In some embodiments, the stabilizer leg 146 may be movable between a first position wherein the at least one outrigger wheel 145 contacts the land surface, and a second position wherein the at least one outrigger wheel 145 does not contact the land surface.

As discussed above, the sail 130 may be configured to capture wind to cause rotation of the wheel 110 about the axle 120, thereby propelling the land sail apparatus 100. The sail 130 may be attached at the wheel 110. Particularly, as shown in FIGS. 1-7, the sail 130 may be attached at one side of the wheel 110 (i.e., a first side), and the outrigger 140 may be attached opposite the sail 130 at another side of the wheel 110 (i.e., a second side).

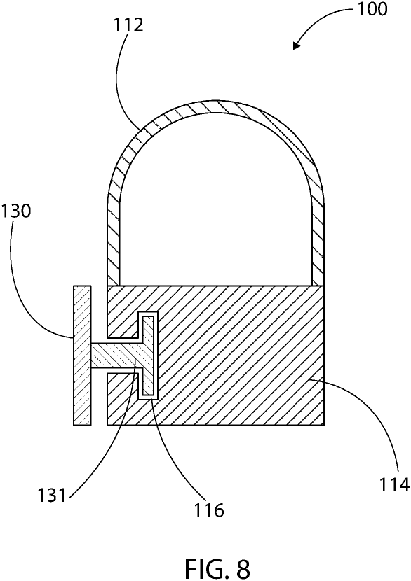

In some embodiments, as shown in FIG. 8, the rim 114 of the wheel 110 may include a peripheral channel 116. In these embodiments, the sail 130 may include at least one peripheral fastener 131 which may be configured for insertion into the peripheral channel 116, thereby attaching the sail 130 to the wheel 110. In some embodiments, the sail 130 may be collapsible. For example, the sail 130 may include a seam and a fastener (not illustrated), such as (but not limited to) hook and loop fastener or magnets, enabling the sail 130 to be collapsed/retracted so that the wind does not blow the sail 130 around when not in use.

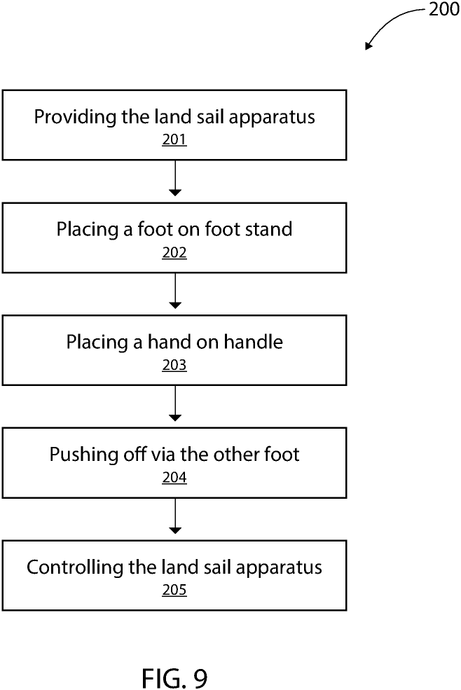

Referring now to FIG. 9 showing a flow diagram illustrating a method of using a land sail apparatus (“method” 200), according to an embodiment of the present disclosure. In particular, the method 200 may include one or more components or features of the land sail apparatus 100 as described above. As illustrated, the method 200 may include the steps of: step one 201, providing the land sail apparatus; step two 202, placing a foot on the foot stand section; step three 203, placing at least one hand on the handle section; step four 204, pushing off from the land surface via the other foot, thereby beginning rotation of the wheel and thus propelling the land sail apparatus, the propulsion of the land sail apparatus being continued by wind power captured at the sail; and step five 205, controlling the land sail apparatus via at least one of the handle section and the foot stand section.

It should be noted that the steps described in the method of use can be carried out in many different orders according to user preference. It should also be noted that, under appropriate circumstances, considering such issues as design preference, user preferences, marketing preferences, cost, structural requirements, available materials, technological advances, etc., other methods for are taught herein.

It should be understood by one of skill in the art that the disclosed invention is described here in a few exemplary embodiments of many. No particular terminology or description should be considered limiting on the disclosure or the scope of any claims issuing therefrom.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the relevant patent offices and the public generally, and especially the scientist, engineers and practitioners in the art who are not familiar with patent or legal terms or phraseology, to determine quickly from a cursory inspection the nature and essence of the technical disclosure of the application.

What is claimed is:

1. A land sail apparatus comprising:
a wheel for contacting a land surface;
an axle attached to a center of the wheel, the wheel configured to rotate about the axle;
a sail attached at the wheel, the sail configured to capture wind to cause rotation of the wheel about the axle, thereby propelling the land sail apparatus; and
a riding assembly attached to the axle and including a foot stand section configured to receive at least one foot of a user, and a handle section configured to receive at least one hand of the user, the riding assembly enabling the user to ride and control the land sail apparatus.

2. The land sail apparatus of claim 1, wherein the riding assembly includes an outrigger.

3. The land sail apparatus of claim 2, wherein the foot stand section is attached at a bottom end of the outrigger, and wherein the handle section is attached at a top end of the outrigger.

4. The land sail apparatus of claim 3, wherein the outrigger includes an elongated shaft attached to the axle substantially at a center point of the elongated shaft and oriented perpendicular to the axle.

5. The land sail apparatus of claim 4, wherein the outrigger includes at least one outrigger wheel for contacting the land surface and providing stabilization and support to the wheel.

6. The land sail apparatus of claim 5, wherein the bottom end of the outrigger further includes a stabilizer leg, and wherein the at least one outrigger wheel is attached to a bottom of the stabilizer leg.

7. The land sail apparatus of claim 6, wherein the wheel includes a diameter of 8 feet.

8. The land sail apparatus of claim 7, wherein the wheel includes a tire, and wherein the tire includes treads for aiding in grip of the land surface.

9. The land sail apparatus of claim 8, wherein the sail is attached at a first side of the wheel, and wherein the outrigger is attached opposite the sail at a second side of the wheel.

10. The land sail apparatus of claim 9, wherein the wheel includes a rim, wherein the rim includes a peripheral channel, wherein the sail includes at least one peripheral fastener, and wherein the at least one peripheral fastener is configured for insertion into the peripheral channel, thereby attaching the sail to the wheel.

11. The land sail apparatus of claim 10, wherein the wheel includes a plurality of equally spaced spokes extending radially from the center of the wheel.

12. A land sail apparatus comprising:
a wheel for contacting a land surface;
an axle attached to a center of the wheel, the wheel configured to rotate about the axle;
a sail attached at a first side of the wheel, the sail configured to capture wind to cause rotation of the wheel about the axle, thereby propelling the land sail apparatus;
an outrigger attached to the axle and opposite the sail at a second side of the wheel;
a foot stand section attached about a bottom end of the outrigger and configured to receive feet of a user; and
a handlebar section attached about a top end of the outrigger and configured to receive hands of the user, the foot stand section and the handlebar section enabling the user to ride and control the land sail apparatus.

13. The land sail apparatus of claim 12, wherein the outrigger includes an elongated shaft attached to the axle substantially at a center point of the elongated shaft and oriented perpendicular to the axle.

14. The land sail apparatus of claim 13, wherein the outrigger includes at least one outrigger wheel for contacting the land surface and providing stabilization and support to the wheel.

15. The land sail apparatus of claim 14, wherein the bottom end of the outrigger further includes a stabilizer leg, and wherein the at least one outrigger wheel is attached to a bottom of the stabilizer leg.

16. The land sail apparatus of claim 15, wherein the wheel includes a diameter of 8 feet.

17. The land sail apparatus of claim 16, wherein the wheel includes a tire, and wherein the tire includes treads for aiding in grip of the land surface.

18. The land sail apparatus of claim 17, wherein the wheel includes a rim, wherein the rim includes a peripheral channel, wherein the sail includes at least one peripheral fastener, and wherein the at least one peripheral fastener is configured for insertion into the peripheral channel, thereby attaching the sail to the wheel.

19. The land sail apparatus of claim 18, wherein the wheel includes a plurality of equally spaced spokes extending radially from the center of the wheel.

20. A method of using a land sail apparatus, the method comprising the steps of:
providing the land sail apparatus including:
a wheel for contacting a land surface;
an axle attached to a center of the wheel, the wheel configured to rotate about the axle;
a sail attached at the wheel, the sail configured capture wind to cause rotation of the wheel about the axle, thereby propelling the land sail apparatus;
an outrigger attached to the axle and providing stabilization and support to the wheel;
a foot stand section attached about a bottom end of the outrigger; and
a handle section attached about a top end of the outrigger;
placing a foot on the foot stand section;
placing at least one hand on the handle section;
pushing off from the land surface via the other foot, thereby beginning rotation of the wheel and thus propelling the land sail apparatus, the propulsion of the land sail apparatus being continued by wind power captured at the sail; and
controlling the land sail apparatus via at least one of the handle section and the foot stand section.
